(19) United States
(12) Patent Application Publication
(10) Pub. No.: US 2018/0365936 A1
(43) Pub. Date: Dec. 20, 2018

(54) METHOD AND SYSTEM FOR PROVIDING BLACKJACK GAME

(71) Applicant: NEON Games Co.,LTD., Seongnam-si (KR)

(72) Inventor: Ki-York KIM, Yongin-si (KR)

(21) Appl. No.: 15/657,569

(22) Filed: Jul. 24, 2017

(30) Foreign Application Priority Data
Jun. 16, 2017 (KR) 10-2017-0076608

(51) Int. Cl. G07F 17/32; G06F 17/30

(52) U.S. Cl. CPC G07F 17/3267; G07F 17/3244; A63F 2001/003; G06F 17/30; G07F 17/3293

(57) ABSTRACT

The present invention relates to a method and a system for providing a blackjack game, and more particularly, a method and a system for providing a blackjack game including steps of providing multiple game modes to a user terminal, providing multiple submodes to the user terminal, providing data to the user terminal, determining and presenting a bet amount, starting a game by giving two cards, selectively receiving an additional card, and determining a winner of the game, which can cause the interest of the game continuously and new fun by introducing competitive elements.

### TECHNICAL FIELD

The present invention relates to a method and a system for providing a blackjack game, and more particularly, to a method and a system for providing a blackjack game, which can cause new fun and excitement because a user can compete with other users or dealers through progress of a game in various modes.

### BACKGROUND ART

As communication technology develops and related technologies such as graphics and sound develop, various types of computer games are emerging. The computer games are being developed as a type of an online game that allows various users to access a game server and enjoy a game through various communication networks, apart from being independently executed in a personal computer. In recent years, a mobile environment has been developed to enjoy the online game through mobile.

With the diversification of the online game, services that make games which are widely performed offline into online and provide the games have increased and as online use is available, and as a result, a utilization rate of the game service has also increased.

Representative games among the games include card games including blackjack, poker, baccarat, and the like. Among them, a blackjack game begins with a dealer and one or more gamers sharing two of a number of cards with different patterns and/or numbers. A purpose of the blackjack game is for the gamer to collect cards with a total score higher than a score of the dealer, not exceeding 21 points.

The card games provided online are advantageous in that a large number of users can play the games without restriction of time and space, thereby expanding a game market and speeding up the spread of the game.

However, since the card game provided online is merely an offline game as it is implemented online, a game rule is simple, and when the card game is repeatedly played for a long time, the interest of the game is easily lost, and as a result, dislike may be caused.

The above information disclosed in this Background section is only for enhancement of understanding of the background of the invention and therefore it may contain information that does not form the prior art that is already known in this country to a person of ordinary skill in the art.

### DISCLOSURE

### Technical Problem

The present invention has been made in an effort to provide a method and a system for providing a blackjack game which can cause an interest of a game by providing various game modes and submodes to a user terminal.

Further, the present has also been made in an effort to provide a method and a system for providing a blackjack game, which can cause a new fun because a user terminal may compete with a character or a dealer character of another user terminal for predetermined prize money or a participation right through a tournament mode.

The technical objects of the present invention are not limited to the aforementioned technical objects, and other technical objects, which are not mentioned above, will be apparently appreciated by those skilled in the art from the description of the present invention.

### Technical Solution

An embodiment of the present invention provides a method for providing a blackjack game that provides a game service to a user terminal via a network, the method including steps of (a) providing multiple game modes stored in a database to a user terminal by confirming access of a character corresponding to the user terminal; (b) providing multiple submodes classified according to at least one of a character level, a bet amount, and a buy-in amount to the user terminal when one of multiple game modes is selected by the user terminal; (c) providing data related to at least one of a character, a holding amount, a bet amount, a dealer character, and multiple cards stored in a database by interlocking with the submode selection of the user terminal; (d) determining and presenting the bet amount by the user terminal; (e) starting the game by giving two cards of the multiple cards to the character of the user terminal and giving two different cards to the dealer character; (f) selectively receiving an additional card to the character according to an operation of the user terminal; and (g) comparing the sum of the figures of the cards given to the character of the user terminal with the sum of the figures of the cards given to the dealer character and determining a character, which reaches a predetermined value or a value adjacent to the predetermined value or less as the winner of the game.

The step (a) may include providing a free bet mode in which an amount obtained by multiplying the bet amount of the user terminal by a predetermined ratio is calculated for each hand and attributed to a holding amount of the user terminal; providing a tournament mode in which the user terminal and another user terminal proceed through one or more rounds of predefined hands to determine the final winner; and providing a spin&go mode in which a user terminal and another user terminal proceed a predetermined hand to allow the final winner to acquire prize money which is arbitrarily determined.

The providing of the free bet mode may include providing 6 submodes classified according to the level of the character to the user terminal, and in each submode, different minimum bet amount and maximum bet amount are determined.

The method may further include determining and presenting, by the user terminal, a bet amount between the minimum bet amount and the maximum bet amount determined in the submode; and further presenting, by the user terminal, an additional bet amount to a character corresponding to another user terminal.

The method may further include further providing a combination bet amount on a condition that the user terminal achieves a specific combination of a card given to the character corresponding to another user terminal; and attributing an amount obtained by multiplying the combination bet amount of the user terminal by a predetermined ratio to a holding amount of the user terminal when the card given to the character corresponding to another user terminal achieves the specific combination.

The providing of the tournament mode may include providing 4 submodes classified according to the level of the character and a buy-in amount, and each submode may start while the user terminals and another user terminal hold the same amount.

The submode may consist of one round including 8 hands and the user terminal having the lowest holding amount in the 4th hand may terminate the game.

The submode may consist of two rounds including 8 hands, the user terminal having the lowest holding amount in the 4th hand may terminate the game, and only the final winner in the first round may participate in the second round.

The submode may consist of two rounds including 12 hands, the user terminal having the lowest holding amount in the 4th hand and the 8th hand may terminate the game, and only the final winner in the first round may participate in the second round.

The submode may include 8 to 12 hands and each user terminal may receive a special change card capable of changing one or more of the two cards given to the character of the user terminal to another card.

The method may further include providing a pendant to the user terminal determined as the final winner in a predetermined number of submodes, in which an order of the user terminals is determined according to the number of pendants.

The step (f) may include giving an additional card to the character of the user terminal when a hit signal is input by the user terminal; giving no additional card to the character of the user terminal when a stand signal is input by the user terminal; and performing a function of the strategy card when a strategy card signal is input by the user terminal.

The giving of the additional card according to the input of the hit signal may be performed by performing a touch operation continuously on a display unit of the user terminal, and the giving of no additional card according to the input of the stand signal may be performed by performing a sweep operation on the display unit of the user terminal.

The performing of the function of the strategy card may include increasing a value of a bonus portion by a predetermined amount when the strategy card signal is inputted by the user terminal; and starting a bonus hand in which a compensation obtained by multiplying a predetermined ratio is provided when the value of the bonus portion reaches a target value.

The step (e) may include reaching the sum of the figures of the two cards given to the character of the user terminal to a predetermined value; inquiring of the user terminal whether to accept even money when a published card among cards given to the dealer character is an ace card; and attributing the same amount as the bet amount to the holding amount of the user terminal when the user terminal accepts the even money and terminating the game.

The step (e) may include inquiring of the user terminal whether to accept insurance when the published card among the cards given to the dealer character is the ace card; and attributing the amount obtained by multiplying the bet amount by a predetermined ratio to the holding amount of the user terminal if the sum of numbers given to the dealer character reaches a predetermined value, when the user terminal accepts the insurance.

The providing of the spin&go mode may include providing two submodes classified according to the buy-in amount to the user terminal, and each submode may start while the user terminals and another user terminal hold the same amount.

The submode consists of one round including 4 hands and the final winner may acquire prize money arbitrarily determined.

Another embodiment of the present invention provides a system for providing a blackjack game including: a network connection unit that authenticates the online access of the user terminal by referring to the online access information stored in the database and connects multiple user terminals to each other; and a game server including a game mode providing unit that provides multiple game modes to the user terminal, a submode providing unit that provides multiple submodes classified according to at least one of a character level, a bet amount, or a buy-in amount, a bet amount unit that presents a bet amount, a card giving unit that gives a card to the character of the user terminal and the dealer character, and a winner determining unit that compares the sum of the figures of cards given to the character of the user terminal with the sum of the figures of cards given to the dealer character to determine the winner of the game.

The game mode providing unit may include a free bet mode providing unit in which an amount obtained by multiplying the bet amount of the user terminal by a predetermined ratio is calculated for each hand and attributed to a holding amount of the user terminal; a tournament mode providing unit in which the user terminal and another user terminal proceed through one or more rounds of predefined hands to determine the final winner; and a spin&go mode proving unit in which the user terminal and another user terminal proceed a predetermined hand to allow the final winner to acquire prize money which is arbitrarily determined.

### Advantageous Effects

The present invention having the above-described configuration provides various game modes and submodes to a user terminal to continuously maintain an interest of a game even though the game is repeatedly played for a long period of time.

Specifically, the present invention can provide various sub-modes constituted by a free bet mode, a tournament mode, and a spin-and-go mode and classified according to one or more of a character level, a bet amount, or a purchase amount.

In particular, the present invention provides a tournament mode in which one or more rounds of multiple hands proceed with a character or a dealer character of another user terminal to determine a final winner to cause a new fun to a user by departing from a simple game method.

In addition, in the present invention, a user terminal having the smallest amount of money held in the 4th hand or 8th hand in the tournament mode is excluded from the game, thereby providing a tension to the game.

Moreover, in the present invention, since pendants are provided to user terminals of a predetermined number, which are determined to be the final winner of a second round or a first round and an overall ranking is determined according to the number of the pendants, different kinds of fun can be provided and users' desire for winning is stimulated to enhance a game participation rate.

As a result, the present invention has an effect of allowing the user to continuously enjoy the game by introducing interesting inducing factors such as a tournament mode, and the like, which are not found in the existing card game.

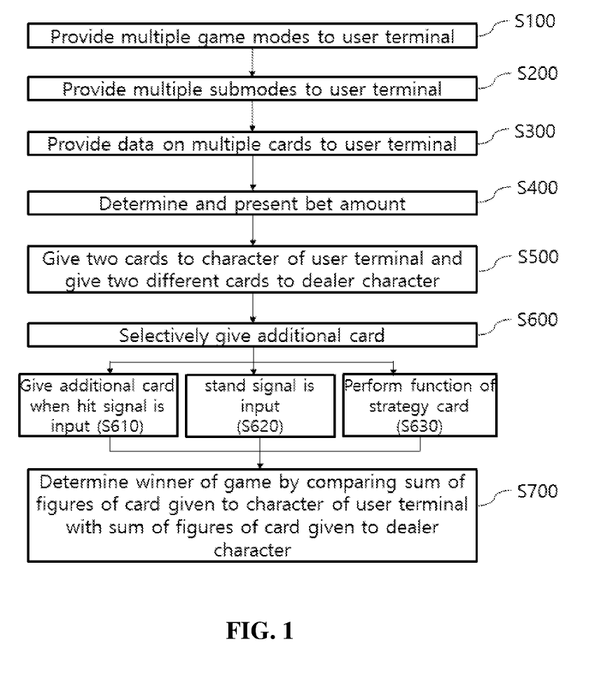

FIG. 1 is a flowchart illustrating a method for providing a blackjack game according to an embodiment of the present invention.

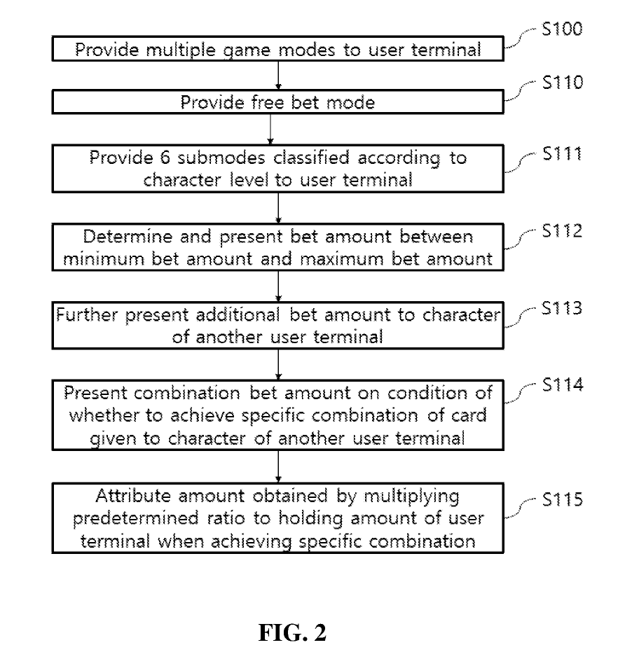

FIG. 2 is a flowchart illustrating a method for providing a free bet mode among multiple game modes according to the embodiment of the present invention.

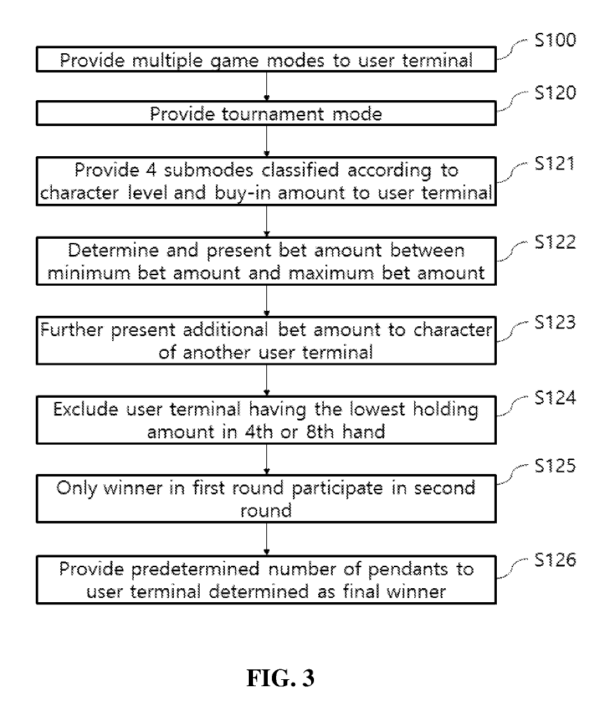

FIG. 3 is a flowchart illustrating a method for providing a tournament mode among multiple game modes according to the embodiment of the present invention.

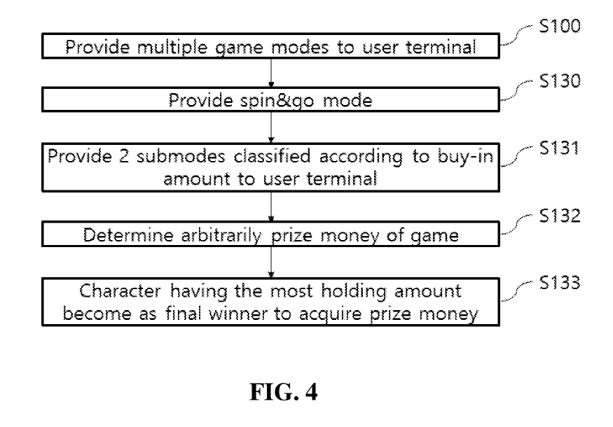

FIG. 4 is a flowchart illustrating a method for providing a spin-and-go mode among multiple game modes according to the embodiment of the present invention.

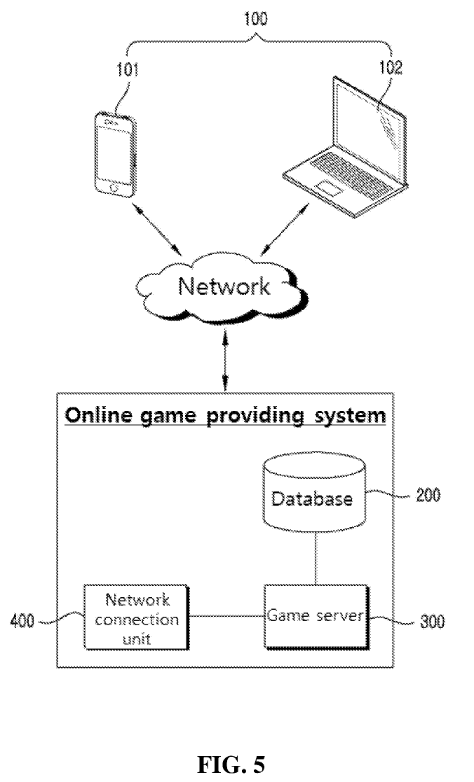

FIG. 5 is a diagram illustrating each component of a system for providing a blackjack game according to an embodiment of the present invention.

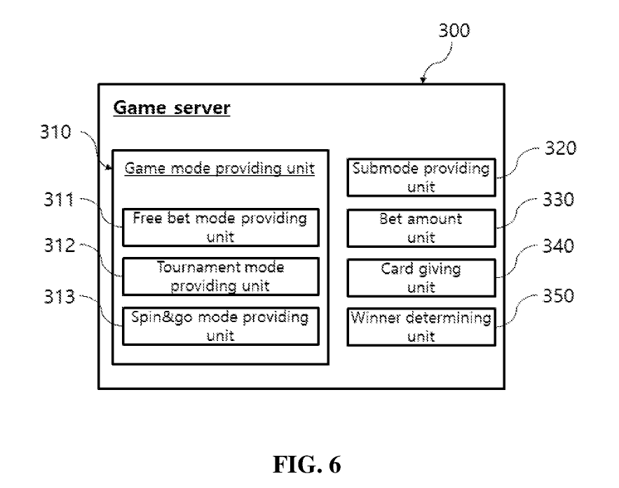

FIG. 6 is a diagram illustrating each component of a game server according to an embodiment of the present invention.

### MODES OF THE INVENTION

The present invention will be described more fully hereinafter with reference to the accompanying drawings, in which exemplary embodiments of the invention are shown. However, the present invention can be realized in various different forms, and is not limited to the exemplary embodiments described herein.

The drawings and description are to be regarded as illustrative in nature and not restrictive. Like reference numerals designate like elements throughout the specification.

Terms or words used in this specification and claims should not be interpreted as being limited to typical or dictionary meanings, but should be interpreted as having meanings and concepts which comply with the technical spirit of the present disclosure, based on the principle that an inventor can appropriately define the concept of the term to describe his/her own invention in the best manner.

FIG. 1 is a flowchart illustrating a method for providing a blackjack game according to an embodiment of the present invention.

As illustrated in FIG. 1, first, when a character corresponding to a user terminal accesses a game, multiple game modes stored in a database is provided to the user terminal and displayed on a display through verification of the access (S100).

Here, the present invention will be described on the basis of an online game, that is, multiple users playing a game through a network, but the technical idea of the present invention can also be applied to a personal computer-based game or a console-based game.

In the embodiment of the present invention, a network, communication, and a communication network may be used as the same meaning. The terms refers to a wired/wireless local area and wide area data transmission/reception network capable of transmitting/receiving a file between a user terminal, a terminal of another user or a download server, but are not limited thereto.

The user terminal which may be connected to an online game providing system via a wired/wireless network includes a PC, a smart phone, a mobile phone, an MP3 player, a TV, a tablet computer, and the like, but if the user terminal satisfies a definition, a shape or a name of the user terminal is not limited.

As described above, when one of the multiple game modes is selected by the user terminal, multiple submodes classified according to at least one of a character level, a bet amount, and a buy-in amount is provided to the user terminal (S200).

The submode may be sequentially provided, which corresponds to the level based on the level of the character corresponding to the user terminal or the multiple submodes may be disclosed at once.

When the game mode and the submode below the game mode are selected in the user terminal, various data such as a character, a holding amount, a bet amount, a dealer character or multiple cards of the user terminal are provided to the user terminal from a database and participation in a game room is achieved (S300).

In the present invention, THE game room refers to a unit of a play in which a user terminal must participate in order to play a game when the user terminal accesses a game server to play a provided online game. In a general online game, an interface capable of preparing for playing the game (for example, setting an item, setting a character, etc.) is provided and the game room and the game may be played in a screen itself on which the game room is displayed in the game play or a separate game screen is output to play the game in the game room.

The user terminal which participates in the game room first sets and proposes the bet amount to the character thereof. As described below, the betting may be performed between the minimum bet amount and the maximum bet amount, and in some cases, an unlimited mode in which the bet amount is not limited may be created.

When all the betting amounts are presented, two of multiple cards are given to the character of the user terminal, and the other two cards are given to the dealer character to start the game (S500).

At this time, the character of each user terminal receives two cards in a face up state in a clockwise direction based on the dealer character, and the dealer character receives two cards in a face down state and then only one card is faced up.

Thereafter, each user terminal determines and operates whether the user's character further receives cards or not (S600). There is no limit to the number of additional cards to be received.

Specifically, when a hit signal is input by the user terminal, the character of the user terminal receives additional cards (S610), and when a stand signal is input by the user terminal, the character of the user terminal no longer receives the additional cards (S620).

The hit signal may be performed by performing a touch operation continuously on the display unit of the user terminal. That is, the user may input the hit signal by clicking a hit button displayed on the display unit or by tapping a finger twice anywhere on the display unit.

The stand signal may be performed by performing a sweeping operation on the display unit of the user terminal. That is, the user may input the stand signal by clicking a stand button displayed on the display unit or by sweeping the entire display unit with the palm.

Further, when a strategy card signal is input by the user terminal, the function of the strategy card is performed (S630). For example, the strategy card may include a surrender card, a split card, and a double down card.

The surrender card is a strategy card that is used when the user's card is called against the face-up card of the dealer character, and the user may get back a half (½) of the bet amount and give up the game.

The split card is a strategy card used when the character of the user terminal receives two identical cards and the user may divide two cards and bet the same amount as the initial bet amount.

The double down card is a strategy card that enables the user to further bet within the initial bet amount under a condition in which the character of the user terminal receives only one card regardless of the sum of the first received cards.

As such, the user terminal may draw the game in a direction favorable to the user by receiving an additional card in addition to the first two cards given or using various strategy cards.

Meanwhile, the step of performing the strategy card function by the user terminal (S630) may include increasing the value of the bonus portion by a predetermined amount when the strategy card signal is inputted by the user terminal, and starting a bonus hand in which a compensation obtained by multiplying a predetermined ratio is provided when the value of the bonus portion reaches a target value.

For example, when the function of the split card or the double down card is performed by the user terminal, the bonus portion is gradually filled, and when the bonus portion is fully filled, double pay hand starts, in which double compensation is performed for all the characters of the user terminal which is playing the game.

Meanwhile, the dealer character additionally receives a card according to a preset rule, or proceeds the game without the additional card. For example, the dealer character may be set to receive unconditionally an additional card if the sum of two cards is less than or equal to 16, and not to receive unconditionally the additional card if the sum of the cards is greater than or equal to 17.

In addition, the dealer characters may not be able to use a strategy card such as a surrender cards, a split card, and a double down card, and an ace card may be set to count to 11 as long as the sum of cards does not exceed 21.

In this way, the character of each user terminal and the dealer character may receive cards according to the number of various cases, and finally, the sum of the number of the cards received to the character of the user terminal and the number sum of the cards received to the dealer character are compared with each other, and a character that reaches a predetermined numerical value (for example, 21) or reaches a value adjacent to the predetermined value or less becomes a winner of the game (S700).

If the character of the user terminal is determined as the winner of the game, the user terminal receives the amount betted by the user, and if the dealer character is determined as the winner of the game, the user terminal loses the amount betted by the user.

When the sum of figures of the two cards which is first received to either the character of the user terminal or the dealer character is 21, 1.5 times of the bet amount is paid or lost and when the sum of figures of the two cards is the same, the bet amount is get back as it is.

If the winner of the game is determined, the game server inquires of each user terminal whether to proceed with the game again, and the user terminal that proceeds the game one more time remains in the game room, and the user terminal which does not proceed the game one more time gets out of the game room and go to the waiting room.

FIG. 2 is a flowchart illustrating a method for providing a free bet mode among multiple game modes according to the embodiment of the present invention.

As illustrated in FIG. 2, the providing of the multiple game modes to the user terminal (S100) may include providing a free bet mode (S110). The free bet mode is a mode in which the most basic blackjack rule is applied, and a mode in which an amount obtained by multiplying the bet amount of the user terminal by a predetermined ratio is calculated for each hand and attributed to a holding amount of the user terminal.

Herein, the hand is a progress unit of the blackjack game and means the number of game boards in which the character of the user terminal presents a bet amount, the character of the user terminal or the dealer character receives two cards, and then the game proceeds to determine the winner.

That is, in the providing of the free bet mode (S110), a game mode in which the winner of the game is determined for each game board and which the holding amount of the user terminal is changed from time to time is provided to the user terminal.

In addition, in the providing of the free bet mode (S110), 6 submodes classified according to the level of the character may be provided to the user terminal (S111). In each submode, different minimum bet amount and maximum bet amount are determined, and one to three user terminals may participate in the game.

Each user terminal participating in the game needs to determine and present the bet amount between the minimum bet amount and the maximum bet amount determined in the submode (S112). At this time, each user terminal may further bet on a character corresponding to another user terminal in addition to the character of the user terminal (S113).

The user terminal may simultaneously bet on its own character and another user terminal, or first bet on the character of the user terminal and then bet on another character.

Furthermore, the user terminal may further present a combination bet amount on the condition that a specific combination of the cards given to the character corresponding to the other user terminal is achieved (S114). If the cards given to another character achieve the specific combination, the user terminal may further receive an amount obtained by multiplying the combination bet amount by a predetermined ratio (S115).

For example, the user terminal may bet on whether to achieve one pair of another character. After the betting is performed, if the first two cards received by another character are cards having the same figure, the user terminal may compensate for 11 times of the bet amount.

FIG. 3 is a flowchart illustrating a method for providing a tournament mode among multiple game modes according to the embodiment of the present invention.

As illustrated in FIG. 3, the providing of the multiple game modes to the user terminal (S100) may include providing a tournament mode (S210).

The tournament mode is a mode in which characters of the multiple user terminals compete with each other and a mode in which the user terminal and another user terminal proceed through one or more rounds of predefined hands to determine the final winner. In the tournament mode, the final winner of the round monopolizes the prize money.

In addition, in the providing of the tournament mode (S120), 4 submodes classified according to the level of the character and a buy-in amount may be provided to the user terminal (S121). Each submode starts while the characters of all the user terminals hold the same amount and competes to obtain a higher amount.

In particularly, the submode may be referred to as Rio de Janeiro casino and consists of one round including 8 hands. This submode proceeds in such a manner that three user terminals participate in the game, and the user terminal having the lowest holding amount in the 4th hand is excluded from the game.

Since the Rio de Janeiro casino submode consists of one round, 8 hands proceed and the character having the greatest final holding amount monopolizes the prize money and the game is terminated.

In addition, the submode may be referred to as Las Vegas casino or Sydney casino, and consists of two rounds including 8 hands. This submode proceeds in such a manner that three user terminals participate in the game, and the user terminal having the lowest holding amount in the 4th hand is excluded from the game.

In the Las Vegas Casino or Sydney Casino submode, only the final winder of the first round may participate in the second round and the final winder in the second round monopolizes the prize money and the game is terminated.

In addition, the submode may be referred to as Macau casino and consists of two rounds including 12 hands. This sub mode proceeds in such a manner that five user terminals participate in the game, and the user terminal having the lowest holding amount in the 4th hand and the 8th hand is excluded from the game.

In the Macau casino submode, like the Las Vegas casino or Sydney casino submode, only the final winner in the first round participates in the second round, and the final winner in the second round monopolizes the prize money.

Meanwhile, the user terminal participating in each submode receives a special change card capable of changing one or more of the two cards given to the character of the user terminal to another card while proceeding with 8 to 12 hands.

The special change card may just be used once by all users, and may add a strategic element to the blackjack game because an unfavorable game to the user terminal may overturn once.

The method of proceeding the game by selecting one of the 4 sub modes of the tournament mode in the user terminal and is similar to that of the free bet mode described above.

That is, each user terminal determines and presents the bet amount between the minimum bet amount and the maximum bet amount (S122), and further bet on another character other than the character of the user terminal (S123).

However, in the providing of the tournament mode (S120), there is a difference in that a user terminal that is excluded from the game occurs in the 4th or 8th hand (S124), and only the winner in the first round except for the Rio de Janeiro casino sub mode participates in the second round (S125).

In addition, the providing of the tournament mode (S120) may include providing a pendant to the user terminal determined as the final winner in a predetermined number of submodes (S125).

For example, the user terminal that wins the second round in the Las Vegas casino submode five times or more may acquire the Las Vegas casino pendant, and various effects may be obtained according to the acquired pendant.

The pendant may be confirmed in a user profile or the like, and the rank of the user terminal is determined according to the number of pendants, thereby improving a game participation rate by stimulating the desire for winning of the users.

Meanwhile, the receiving of two cards to the character of the user terminal and the dealer character (S500) may include steps of reaching the sum of the figures of the two cards given to the character of the user terminal to a predetermined value, inquiring to the user terminal whether to accept even money when a published card among cards given to the dealer character is an ace card, and attributing the same amount as the bet amount to the holding amount of the user terminal when the user terminal accepts the even money and terminating the game.

For example, while the character of the user terminal receives the ace card and the card of number 10 and completes the blackjack, and when the face-up card of the cards given to the dealer character is an ace card, the user terminal reaches a crossroad.

If the dealer character is blackjack, the characters tie, but if the dealer character is not blackjack, 1.5 times of the bet amount is paid. In this case, the user may receive the same amount as the bet amount of the user instead of watching the game with the dealer character and terminate the game.

Further, the receiving of the two cards to the character of the user terminal and the dealer character (S500) may include inquiring of the user terminal whether to accept insurance when the published card among the cards given to the dealer character is the ace card, and attributing the amount obtained by multiplying the bet amount by a predetermined ratio to the holding amount of the user terminal if the sum of numbers given to the dealer character reaches a predetermined value, when the user terminal accepts the insurance.

For example, when the opened card of the two cards received by the dealer character is the ace card, the user terminal may accept the insurance against the case where the dealer character is the blackjack. If the dealer character is not the blackjack, the insurance amount is lost, but if the dealer character is the blackjack, double the insurance amount may be received.

FIG. 4 is a flowchart illustrating a method for providing a spin-and-go mode among multiple game modes according to the embodiment of the present invention.

As illustrated in FIG. 4, the providing of the multiple game modes to the user terminal (S100) may include providing a spin&go mode (S130). The spin&go mode is a mode in which the prize money is arbitrarily determined in advance, and then a user terminal and another user terminal proceed a predetermined hand to determine a final winner.

Further, in the providing of the spin&go mode (S130), two submodes classified according to the buy-in amount may be provided to the user terminal (S131). Each submode may participate in the character level without limitation and starts while the characters of all user terminals hold the same amount.

The submode is formed on one round including 4 hands and at the start of the game, one of 10 types of prize money is randomly determined as the prize money of the winner (S132).

The positions of the characters of all the user terminals are randomly determined, and 4 hands proceed, and finally, the character having the largest holding amount becomes the final winner to monopolize the prize money (S133).

FIG. 5 is a diagram illustrating each component of a system for providing a blackjack game according to an embodiment of the present invention.

As illustrated in FIG. 5, a system for providing a blackjack game according to an embodiment of the present invention includes a database 200 that stores data relating to a character corresponding to the user terminal 100, a holding amount, a bet amount, a dealer character, or at least one of multiple cards, and a game server 300 that is connected to at least one user terminal via a wired/wireless network to provide a game service.

In the present invention, the user terminals 100 are divided into a first user terminal 101 and a second user terminal 102 for convenience, but it is merely an example that multiple user terminals may be used, but the present invention is not limited thereto.

The database 200 may further store online access information such as an ID of a user terminal, a password, etc., and user information such as an account owned by the user terminal, a winning ratio, nickname information, etc. in addition to the game-related data.

The game server 300 means a server unit that logically provides an online game and may be implemented as a single server group composed of multiple servers or as multiple computing devices capable of distributed processing. In addition, the game server 300 may be connected to a physically independent database 200, or may be configured to include a database.

Further, the system for providing the blackjack game according to the embodiment of the present invention may further include a network connection unit 400.

The network connection unit 400 may authenticate the online access of the user terminal by referring to the online access information stored in the database to access the network and participate in the game.

Furthermore, the network connection unit 400 may connect multiple user terminals to each other by interlocking with the partition request of the game room and provide a character corresponding to the user terminal, a game screen, and the like.

FIG. 6 is a diagram illustrating each component of a game server according to an embodiment of the present invention.

As illustrated in FIG. 6, the game server 300 according to the embodiment of the present invention includes a game mode providing unit 310, a submode providing unit 320, a bet amount unit 330, a card giving unit 340, and a winner determining unit 350.

The game mode providing unit 310 provides multiple game modes to the user terminal. The game mode providing unit 310 may further include a free bet mode providing unit 311, a tournament mode providing unit 312, and a spin& go mode providing unit 313.

The free bet mode providing unit 311 may calculate an amount obtained by multiplying the bet amount of the user terminal by a predetermined ratio for each hand to attribute the calculated amount to the holding amount of the user terminal, the tournament mode providing unit 312 proceeds one or more rounds consisting of hands predetermined by the user terminal and another user terminal to determine a final winner, and the spin& go mode providing unit 313 proceeds the hands predetermined by the user terminal and another user terminal to allow the final winner to acquire randomly determined prize money.

The submode providing unit 320 provides to the user terminal multiple submodes classified according to at least one of the level of the character, the bet amount, and the buy-in amount. As described above, the submode providing unit provides a submode consisting of one round or multiple rounds including 1 to 12 hands according to a selection of the game mode.

The bet amount unit 330 allows the character to present the bet amount determined by the user terminal. The betting by the bet amount part may be different depending on each game mode or the submode, and the bet amount part may set the minimum bet amount and the maximum bet amount.

Further, the bet amount unit 330 may further bet on the character of another user terminal or present a combination bet amount on the premise that a specific combination is achieved.

The card giving unit 340 allows two cards among the multiple cards to be given to the character of the user terminal and other two cards to be given to the dealer character or an additional card to be selectively given to the dealer character.

Furthermore, the card giving unit 340 may provide a strategy card or a special change card to the user terminal to improve the fun of the game. The card giving unit may increase the bonus value when using the strategy card by interlocking with the bonus.

The winner determining unit 350 compares the sum of the figures of cards given to the character of the user terminal with the sum of the figures of cards given to the dealer character to determine the winner of the game and pays the prize money.

The winner determining unit 350 may determine the winner for each hand and pay the bet amount or may proceed 4 to 12 hands to pay the prize money to the final winner.

The above-described embodiments of the present invention may be embodied in the form of a computer program that can be executed on a computer through various components, and such a computer program may be recorded on a computer-readable medium. In this case, the medium may include hardware devices, such as a magnetic medium such as a hard disk, a floppy disk and a magnetic tape, an optical recording medium such as CD-ROM and a DVD, a magneto-optical medium such as a floptical disk, a ROM, a RAM, a flash memory, and the like, which are specifically configured to store and execute program instructions. Further, the medium may include invisible media that are implemented in a form that can be transmitted over a network, and for example, may be implemented in software or an application form to be transmitted and distributed through a network.

Meanwhile, the computer program may be specifically designed and configured for the present invention or may be known and used by a person skilled in the art of computer software. An example of the computer program includes a high-level language code executable by a computer by using an interpreter and the like, as well as a machine language code created by a compiler.

The aforementioned present invention is not limited to the aforementioned exemplary embodiments and the accompanying drawings, and it will be obvious to those skilled in the technical field to which the present invention pertains that various substitutions, modifications, and changes may be made within the scope without departing from the technical spirit of the present invention.

### EXPLANATION OF REFERENCE NUMERALS

100: User terminal
200: Database
300: Game server
400: Network connection unit

1. A method for providing a blackjack game that provides a game service to a user terminal via a network, the method comprising steps of:
(a) providing multiple game modes stored in a database to a user terminal by confirming access of a character corresponding to the user terminal;
(b) providing multiple submodes classified according to at least one of a character level, a bet amount, and a buy-in amount to the user terminal when one of multiple game modes is selected by the user terminal;
(c) providing data related to at least one of a character, a holding amount, a bet amount, a dealer character, and multiple cards stored in a database by interlocking with the submode selection of the user terminal;
(d) determining and presenting the bet amount by the user terminal;
(e) starting the game by giving two cards of the multiple cards to the character of the user terminal and giving two different cards to the dealer character;
(f) selectively receiving an additional card to the character according to an operation of the user terminal; and
(g) comparing the sum of the figures of the cards given to the character of the user terminal with the sum of the figures of the cards given to the dealer character and determining a character, which reaches a predetermined value or a value adjacent to the predetermined value or less as the winner of the game.

2. The method of claim 1, wherein the step (a) includes
providing a free bet mode in which an amount obtained by multiplying the bet amount of the user terminal by a predetermined ratio is calculated for each hand and attributed to a holding amount of the user terminal;
providing a tournament mode in which the user terminal and another user terminal proceed through one or more rounds of predefined hands to determine the final winner; and
providing a spin&go mode in which a user terminal and another user terminal proceed a predetermined hand to allow the final winner to acquire prize money which is arbitrarily determined.

3. The method of claim 2, wherein the providing of the free bet mode includes
providing 6 submodes classified according to the level of the character to the user terminal, and in each submode, different minimum bet amount and maximum bet amount are determined.

4. The method of claim 3, further comprising:
determining and presenting, by the user terminal, a bet amount between the minimum bet amount and the maximum bet amount determined in the submode; and
further presenting, by the user terminal, an additional bet amount to a character corresponding to another user terminal.

5. The method of claim 4, further comprising:
further providing a combination bet amount on a condition that the user terminal achieves a specific combination of a card given to the character corresponding to another user terminal; and
attributing an amount obtained by multiplying the combination bet amount of the user terminal by a predetermined ratio to a holding amount of the user terminal when the card given to the character corresponding to another user terminal achieves the specific combination.

6. The method of claim 2, wherein the providing of the tournament mode includes
providing 4 submodes classified according to the level of the character and a buy-in amount, and
each submode starts while the user terminals and another user terminal hold the same amount.

7. The method of claim 6, wherein the submode consists of one round including 8 hands and the user terminal having the lowest holding amount in the 4th hand terminates the game.

8. The method of claim 6, wherein
the submode consists of two rounds including 8 hands, the user terminal having the lowest holding amount in the 4th hand terminates the game, and only the final winner in the first round participates in the second round.

9. The method of claim 6, wherein the submode consists of two rounds including 12 hands, the user terminal having the lowest holding amount in the 4th hand and the 8th hand terminates the game, and only the final winner in the first round participates in the second round.

10. The method of claim 6, wherein the submode includes 8 to 12 hands and each user terminal receives a special change card capable of changing one or more of the two cards given to the character of the user terminal to another card.

11. The method of claim 6, further comprising:
providing a pendant to the user terminal determined as the final winner in a predetermined number of submodes,
wherein an order of the user terminals is determined according to the number of pendants.

12. The method of claim 1, wherein the step (f) includes
giving an additional card to the character of the user terminal when a hit signal is input by the user terminal;
giving no additional card to the character of the user terminal when a stand signal is input by the user terminal; and
performing a function of the strategy card when a strategy card signal is input by the user terminal.

13. The method of claim 12, wherein
the giving of the additional card according to the input of the hit signal is performed by performing a touch operation continuously on a display unit of the user terminal, and
the giving of no additional card according to the input of the stand signal is performed by performing a sweep operation on the display unit of the user terminal.

14. The method of claim 12, wherein the performing of the function of the strategy card includes
increasing a value of a bonus portion by a predetermined amount when the strategy card signal is inputted by the user terminal; and
starting a bonus hand in which a compensation obtained by multiplying a predetermined ratio is provided when the value of the bonus portion reaches a target value.

15. The method of claim 1, wherein the step (e) includes reaching the sum of the figures of the two cards given to the character of the user terminal to a predetermined value;
inquiring of the user terminal whether to accept even money when a published card among cards given to the dealer character is an ace card; and
attributing the same amount as the bet amount to the holding amount of the user terminal when the user terminal accepts the even money and terminating the game.

16. The method of claim 1, wherein the step (e) includes
inquiring of the user terminal whether to accept insurance when the published card among the cards given to the dealer character is the ace card; and
attributing the amount obtained by multiplying the bet amount by a predetermined ratio to the holding amount of the user terminal if the sum of numbers given to the dealer character reaches a predetermined value, when the user terminal accepts the insurance.

17. The method of claim 2, wherein the providing of the spin&go mode includes
providing two submodes classified according to the buy-in amount to the user terminal, and
each submode starts while the user terminals and another user terminal hold the same amount.

18. The method of claim 17, wherein the submode consists of one round including 4 hands and the final winner acquires prize money arbitrarily determined.

19. A system for providing a blackjack game comprising:
a network connection unit that authenticates the online access of the user terminal by referring to the online access information stored in the database and connects multiple user terminals to each other; and
a game server including a game mode providing unit that provides multiple game modes to the user terminal, a submode providing unit that provides multiple submodes classified according to at least one of a character level, a bet amount, or a buy-in amount, a bet amount unit that presents a bet amount, a card giving unit that gives a card to the character of the user terminal and the dealer character, and a winner determining unit that compares the sum of the figures of cards given to the character of the user terminal with the sum of the figures of cards given to the dealer character to determine the winner of the game.

20. The system for providing the blackjack game of claim 19, wherein the game mode providing unit includes
a free bet mode providing unit in which an amount obtained by multiplying the bet amount of the user terminal by a predetermined ratio is calculated for each hand and attributed to a holding amount of the user terminal;
a tournament mode providing unit in which the user terminal and another user terminal proceed through one or more rounds of predefined hands to determine the final winner; and
a spin&go mode providing unit in which the user terminal and another user terminal proceed a predetermined hand to allow the final winner to acquire prize money which is arbitrarily determined.
